(19) United States
(12) Patent Application Publication
(10) Pub. No.: US 2024/0344880 A1
(43) Pub. Date: Oct. 17, 2024

(54) SOUND DETECTION DEVICE FOR A VEHICLE

(71) Applicant: GM GLOBAL TECHNOLOGY OPERATIONS LLC, Detroit, MI (US)

(72) Inventors: Gerard Parij, Warren, MI (US); Wendell G. Summerville, West Bloomfield, MI (US)

(21) Appl. No.: 18/300,868

(22) Filed: Apr. 14, 2023

(51) Int. Cl. G01H 17/00; G01S 3/808

(52) U.S. Cl. CPC G01H 17/00; G01S 3/8083

(57) ABSTRACT

A monitoring system of a vehicle includes a sound detection device including a sound transducer attached to a transparent component of the vehicle, the sound detection device configured to detect vibrations of the transparent component due to a sound originating from an external environment around the vehicle. The monitoring system also includes a processor configured to detect a signal generated by the sound transducer, the signal indicative of the sound.

### INTRODUCTION

The subject disclosure relates to detection systems, and more particularly to sound detection based on sound detection devices coupled to transparent vehicle components.

Vehicles, including gasoline and diesel power vehicles, as well as electric and hybrid electric vehicles, increasingly feature various monitoring or detection systems to facilitate driver awareness and/or for control of vehicle functions. For example, optical cameras are used to allow a driver to see regions around a vehicle. Optical and radar systems can be used to enhance awareness, and can be used by autonomous and semi-autonomous vehicle systems. It is desirable to provide systems and devices to further enhance the ability of a driver and/or vehicle system to accurately assess a vehicle's surroundings.

### SUMMARY

In one exemplary embodiment, a monitoring system of a vehicle includes a sound detection device including a sound transducer attached to a transparent component of the vehicle, the sound detection device configured to detect vibrations of the transparent component due to a sound originating from an external environment around the vehicle. The monitoring system also includes a processor configured to detect a signal generated by the sound transducer, the signal indicative of the sound.

In addition to one or more of the features described herein, the transparent component includes a first rigid transparent layer bonded to a second rigid transparent layer by a deformable material, and the sound transducer is disposed in the deformable material.

In addition to one or more of the features described herein, the first rigid transparent layer is an external layer exposed to the external environment, the second rigid transparent layer is an internal layer, and the sound transducer is disposed in contact with the external layer.

In addition to one or more of the features described herein, the sound transducer is affixed to an interior surface of the transparent component.

In addition to one or more of the features described herein, the sound transducer includes a piezoelectric material.

In addition to one or more of the features described herein, the processor is configured to determine at least one of a direction of a source of the sound, and a distance of the source from the vehicle, and output an indication of at least one of the direction of the source of the sound and the distance of the source of the sound.

In addition to one or more of the features described herein, the processor is configured to output the indication by controlling a speaker of the vehicle, the speaker being in a region of the vehicle that corresponds to a location of the sound transducer.

In addition to one or more of the features described herein, the processor is configured to track the direction of the source of the sound, and indicate a change in the direction of the source of the sound by transitioning outputs between different speakers.

In addition to one or more of the features described herein, the transparent component is selected from laminated glass and tempered glass, the transparent component forming a vehicle window.

In another exemplary embodiment, a method of monitoring an environment around a vehicle includes detecting a sound by a sound detection device including a sound transducer attached to a transparent component of the vehicle, wherein detecting the sound includes detecting vibrations of the transparent component due to the sound. The method also includes detecting a signal generated by the sound transducer in response to the vibrations, and generating a notification indicative of the sound.

In addition to one or more of the features described herein, the transparent component includes a first rigid transparent layer bonded to a second rigid transparent layer by a deformable material, and the sound transducer is disposed in the deformable material.

In addition to one or more of the features described herein, the first rigid transparent layer is an external layer exposed to an external environment, the second rigid transparent layer is an internal layer, and the sound transducer is disposed in contact with the external layer.

In addition to one or more of the features described herein, the sound transducer is affixed to an interior surface of the transparent component.

In addition to one or more of the features described herein, the method further includes determining at least one of a direction of a source of the sound, and a distance of the source from the vehicle, and outputting an indication of at least one of the direction of the source of the sound and the distance of the source of the sound.

In addition to one or more of the features described herein, outputting the indication includes controlling a speaker of the vehicle, the speaker being in a region of the vehicle that corresponds to a location of the sound transducer.

In addition to one or more of the features described herein, the method further includes tracking the direction of the source of the sound, and indicating a change in the direction of the source of the sound by transitioning outputs between different speakers.

In yet another exemplary embodiment, a vehicle system includes a memory having computer readable instructions, and a processor for executing the computer readable instructions, the computer readable instructions controlling the processor to perform a method. The method includes detecting a sound by a sound detection device including a sound transducer attached to a transparent component of the vehicle, where detecting the sound includes detecting vibrations of the transparent component due to the sound, and detecting a signal generated by the sound transducer in response to the vibrations, and generating a notification indicative of the sound.

In addition to one or more of the features described herein, the method further includes determining at least one of a direction of a source of the sound, and a distance of the source from the vehicle, and outputting an indication of at least one of the direction of the source of the sound and the distance of the source of the sound.

In addition to one or more of the features described herein, outputting the indication includes controlling a speaker of the vehicle, the speaker being in a region of the vehicle that corresponds to a location of the sound transducer.

In addition to one or more of the features described herein, the method further includes tracking the direction of the source of the sound, and indicating a change in the direction of the source of the sound by transitioning outputs between different speakers.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle and a monitoring system including one or more sound detection devices, in accordance with an exemplary embodiment;

FIG. 2 is a perspective view of a motor vehicle and a monitoring system including one or more sound detection devices, in accordance with an exemplary embodiment;

FIG. 3 depicts an example of a sound detection device having a piezoelectric transducer;

FIG. 4 depicts a portion of a vehicle window, and a sound detection device embedded in the window, in accordance with an exemplary embodiment;

FIG. 5 depicts a portion of a vehicle window, and a sound detection device attached to an interior surface of the window, in accordance with an exemplary embodiment;

FIG. 6 is a flow diagram depicting aspects of a method of monitoring vehicle surroundings, in accordance with an exemplary embodiment; and

FIG. 7 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for acoustic detection or sound detection. An embodiment of a monitoring system includes one or more sound detection devices (e.g., microphones) embedded within or attached to surfaces of transparent components of a vehicle, such as a windshield, rear window, sunroof and/or side window of the vehicle. A “transparent component” refers to a window or other component that is made from a transparent material. For example, a transparent component is a glass component such as a laminated glass panel or a tempered glass panel. In other examples, a transparent component is or includes a rigid plastic or polymer material (e.g., polycarbonate).

Each sound detection device includes a sound or acoustic transducer that is fixedly attached to, and acoustically coupled to, a window or other transparent component, so that sound waves incident on the window are detected. In an embodiment, the transducer is a microphone, such as a piezoelectric contact microphone, that can pick up external sounds by detecting vibrations in a window. Sound detection devices can be disposed at various locations to provide directionality in sound detection.

In an embodiment, the monitoring system includes a processor (e.g., a processor of an existing vehicle system) electrically connected to each sound detection device. The processor can detect transducer signals and determine a direction from which a sound (i.e., acoustic signal) is emitted based on, for example, which device picked up the sound, or which device most clearly picked up the sound. In addition, a distance of a source of the sound from a vehicle can be inferred based on amplitudes of detected acoustic signals. Movement can be inferred based on, for example, changes in detected acoustic signals and/or changes as to which device most clearly detects the signals. Such information can be imparted to a user or vehicle system via various indicators or notifications (e.g., visual, auditory, haptic, etc.).

In an embodiment, the monitoring system is connected to a vehicle's entertainment/sound system to enable the monitoring system to control vehicle speakers. Signals from transducers may be amplified and transmitted to the speakers so that a driver can clearly hear external sounds, which may otherwise be muffled or entirely unheard.

Embodiments described herein present numerous advantages and technical effects. For example, the embodiments enhance awareness of surroundings by detecting sounds and providing information to a user, by transmitting the sounds and/or by providing alerts or other indicators. The monitoring system described herein can be unobtrusively installed and can utilize existing vehicle systems, and may provide improved detection ranges as compared to existing systems (e.g., existing rear backup sensors or cameras). In addition, embodiments can supplement existing detection systems, such as camera, radar and lidar systems. The monitoring system can also be effectively used in conditions, such as snow, ice, dust and other debris on a vehicle, in which the ability of camera and radar systems may be compromised.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

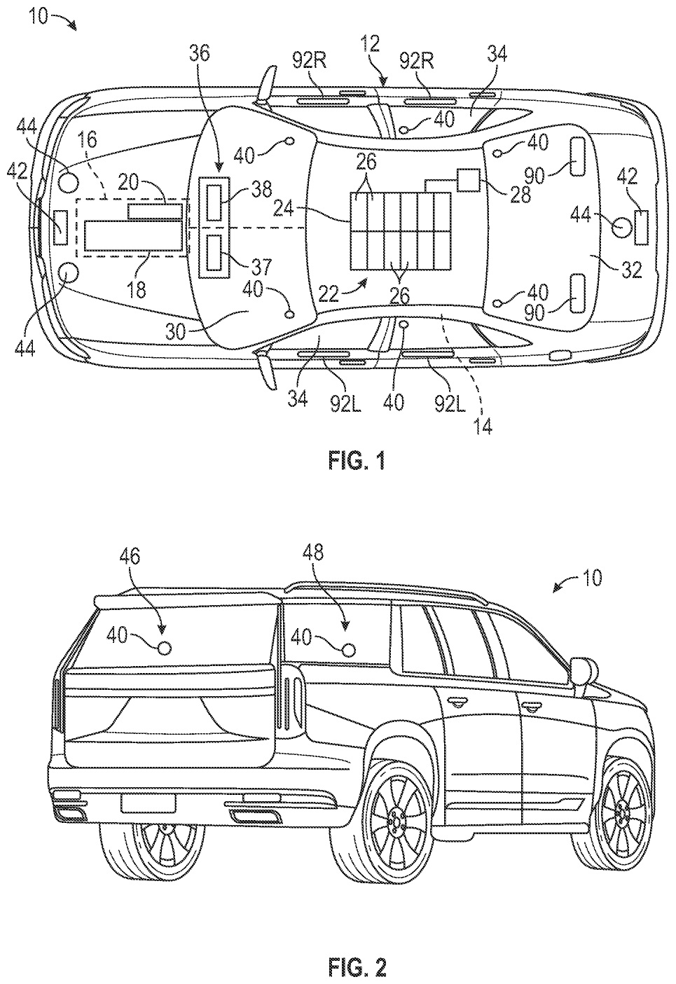

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid electric vehicle (HEV). In an example, the vehicle 10 is a hybrid vehicle that includes a combustion engine system 18 and one or more electric motors 20.

The vehicle 10 may include a battery system 22, which may be electrically connected to the motor assembly 20 and/or other components, such as vehicle electronics. In an embodiment, the battery system 22 includes a battery assembly such as a high voltage battery pack 24 having a plurality of battery modules 26.

In an embodiment, the battery assembly 22 is configured as a rechargeable energy storage system (RESS) which includes various sensors and a monitoring unit or controller 28 (e.g., a RESS controller). The monitoring unit 28 includes components such as a processor, memory, an interface, a bus and/or other suitable components.

The vehicle 10 also includes components for monitoring aspects of an environment around the vehicle 10. An embodiment of the vehicle 10 includes one or more sound detection devices 40 that are integrated into (and/or attached to) transparent components of the vehicle 10. In an embodiment, a sound detection device 40 (or devices) is attached to a window, such as a windshield 30, a rear window 32, and/or a side window 34. Other vehicle transparent components include, for example, a sunroof (not shown).

As described herein, a “transparent component” or “window” refers to any part or material that can be used in a vehicle and provides some level of transparency. In an embodiment, a transparent component is a glass component that includes a glass material. Examples include tempered glass and laminated glass. For example, the windshield 30 is made from tempered glass, and the rear window 32 and/or side windows 34 are made from laminated glass. It is noted that embodiments are not limited to glass materials, as a transparent component may include a polymer material (e.g., polycarbonate).

As shown in FIG. 1, the vehicle 10 includes a sound detection device 40 at one or more locations in the vehicle 10. For example, the rear window 32 includes one or more sound detection devices 40 embedded in the rear window 32. The vehicle 10 may also include one or more sound detection devices 30 embedded in one or more side windows 34. The locations and number of sound detection devices are not limited to the examples shown in FIG. 1.

The vehicle 10 may include other systems and components for monitoring a vehicle environment. The vehicle 10 may include one or more optical cameras 42 configured to take images, which may be still images and/or video images. Additional devices or sensors may be included, such as one or more radar assemblies 44 included in the vehicle 10. The vehicle 10 is not so limited and may include other types of sensors, such as infrared cameras.

As discussed further herein, the sound detection device(s) 40 are used to detect sounds and provide a driver or vehicle system with a notification regarding detected sounds. A “notification” may refer to reproduction of detected sounds (e.g., amplifying and transmitting transducer signals to a vehicle speaker or speakers), or generation of an alert or indication. The alert or indication may be visual (e.g., via a display), audible (e.g., voice alert) or have any suitable form. In addition, an alert or indication may provide information indicative of conditions such as a direction and/or distance of a source of a detected sound (e.g., a vehicle, a siren, a pedestrian, etc.).

Notifications may be used to enhance the driver's awareness of the vehicle surroundings. For example, the vehicles' speaker system can be used in conjunction with the monitoring system to allow the driver to hear external sounds (e.g., when backing up or parking). In addition, or alternatively, notifications may be used by a semi-autonomous vehicle system (e.g., parking assist, highway driving assistance) or autonomous vehicle system (e.g., having various levels of autonomy).

The sound detection device(s) 40 may be implemented in conjunction with other sensors, sensing devices and monitoring systems. Detection and monitoring functions of the sound detection devices 40 may be used in conjunction with other sensing devices. For example, the vehicle 10 includes one or more sensors (e.g., the cameras 42 and/or radar assemblies 44) to enhance monitoring object detection and/or image recognition.

The vehicle 10 also includes an on-board computer system 36 that includes one or more processing devices 37 and a user interface 38. The user interface 38 may include a touchscreen, a speech recognition system and/or various buttons for allowing a user to interact with features of the vehicle. The user interface 38 may be configured to interact with the user via visual communications (e.g., text and/or graphical displays), tactile communications or alerts (e.g., vibration), and/or audible communications.

In addition to the user interface 38, the vehicle 10 may include other types of displays and/or other devices that can interact with and/or impart information to a user. For example, the vehicle 10 includes one or more heads up displays (HUDs). Other devices that may be incorporated include indicator lights, haptic devices, interior lights, auditory communication devices, and others.

The computer system 36 may be in operable communication with the sound detection devices 40, and present information visually in a display and/or in audible form. In an embodiment, the computer system 36 provides audible indications, which may include voice indications, other indications (e.g., beeps) and/or a reproduction of detected sounds.

For example, if a siren sound is detected, one or more speakers in the vehicle 10 (e.g., one of rear speakers 90, left side speakers 92L and right side speakers 92R) output a corresponding siren sound. Audible indicators (speaker outputs) can be provided selectively by activating individual speakers to provide directional information (e.g., a sound detected by a right rear device causes an audible indicator or reproduction of the sound to be output from a rear right side speaker 92R) and movement information (e.g., as a source of sound moves and is detected by different devices, speakers at corresponding regions of the vehicle are respectively activated). Other forms of communication such as haptics (e.g., vibration), can be used to assist in alerting a user and/or drawing the user's attention.

The various processing devices and units may communicate with one another via a communication device or system, such as a controller area network (CAN) or local interconnect network (LIN) bus.

FIG. 2 depicts an example of the vehicle 10 and an example of desired locations at which sound detection devices 40 can be located. In this example, the vehicle 10 is a sport utility vehicle (SUV), and the sound detection devices 40 are provided at locations conducive to detecting features of an environment around rear sections of the vehicle. As shown, at least one sound detection device 40 is located at a rear window 46 and at cargo space side windows 48 near the rear of the vehicle 10.

Such locations are beneficial, for example, when the vehicle 10 is in reverse, and the sound detection devices 40 enhance the driver's and/or vehicle's awareness when the vehicle 10 is moving in reverse and rear views are limited. It is noted that sound detection devices 40 can be disposed at any desired location(s) to facilitate awareness under a variety of conditions and vehicle operating modes.

One or more sound detection devices 40 may be incorporated into a detection or monitoring system that can detect a direction, location and/or distance of objects in an environment around a vehicle. An “object” refers to any feature, condition or physical object in an environment that could potentially affect vehicle operation. Examples of objects include vehicles (e.g., passenger vehicles, trucks, emergency vehicles, trains, etc.), bicyclists, pedestrians and others.

The monitoring system can “listen” for objects by detecting sounds via the sound detection devices 40, which act as microphones. Each transducer is acoustically coupled to a transparent component, so that sound waves incident on the component are detected.

In an embodiment, a sound detection device 40 includes a piezoelectric transducer or other suitable form of transducer (e.g., diaphragm or condensed microphone) that is affixed to a transparent component. The transducer may be attached to an interior surface (e.g., for tempered glass), or embedded in the transparent component (e.g., embedded in laminated glass glazing).

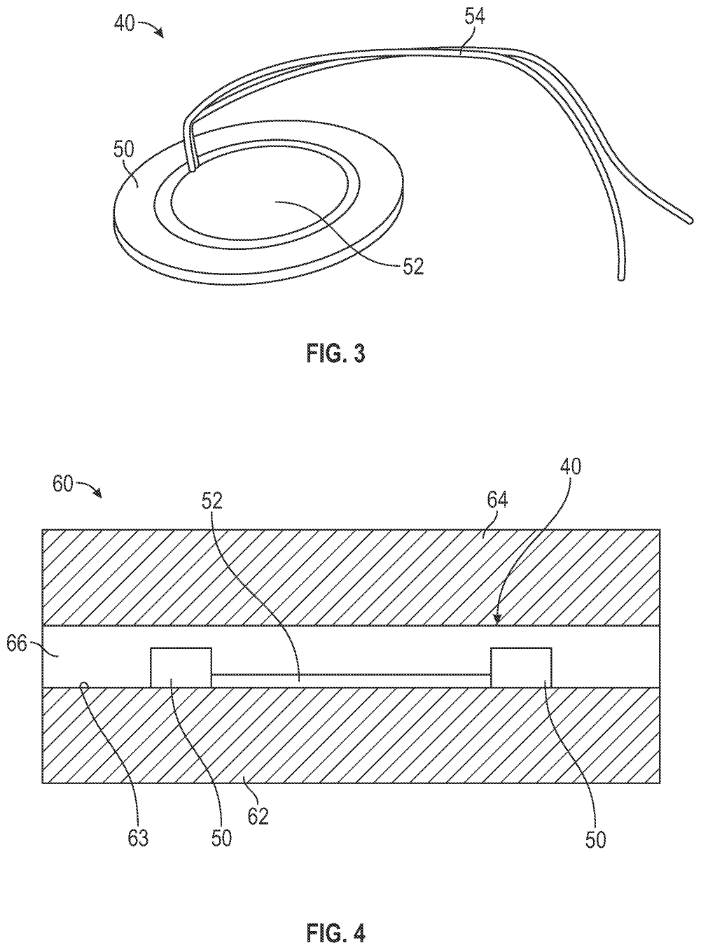

An example of a piezoelectric sound detection device 40 is shown in FIG. 3. The device 40 includes a piezoelectric transducer having a disc 50 made from brass or other suitable conductive material. A layer of piezoelectric material 52 is bonded to the disc 50. The piezoelectric material 52 is, for example, ceramic or polymer.

The transducer is connectable to a vehicle system via conductors such as flat wire leads 54. The leads 54 can be connected to a vehicle bus to electrically connect the device to a vehicle system, such as the computer system 36 and/or vehicle entertainment system.

FIG. 4 depicts an example of the sound detection device 40 including a piezoelectric disc 50 as attached to a transparent component. In this example, the transparent component is a window 60 made from laminated glass. The laminated glass includes an outer or external glass layer 62 that typically faces an exterior of the vehicle 10. The external glass layer 62 is affixed to an internal or interior glass layer 64 by a lamination 66.

The transducer is embedded within the lamination 66, and has a size or thickness that is less than a thickness of the lamination 66. For example, the thickness of each glass layer 62, 64 is between about 1.8 mm to about 2.3 mm, and the lamination 66 has a thickness of about 0.6 to about 1 mm. The thickness of the piezoelectric transducer including the disc 50 and piezoelectric layer 52 is, for example, about 0.5 mm.

The piezoelectric disc 50 is attached to the external glass layer 62 by embedding in the lamination 66 such that the disc 50 is in contact with an inner surface 63 of the external glass layer 62 or is otherwise acoustically coupled to the external glass layer 62.

The glass layers are rigid, and the lamination 66 is deformable and flexible. The external glass layer 62 vibrates due to incident sound waves, and the lamination 66 has a flexibility or deformability that is sufficient to permit deformation of the piezoelectric layer 52 in response to vibrations. For example, the lamination 66 is made from a polymer material such as polyvinyl butyral (PVB) or polyvinyl Chloride (PVC). It is noted that the piezoelectric disc 50 can be affixed in any suitable manner such that acoustic vibrations are picked up by the sound detection device 40.

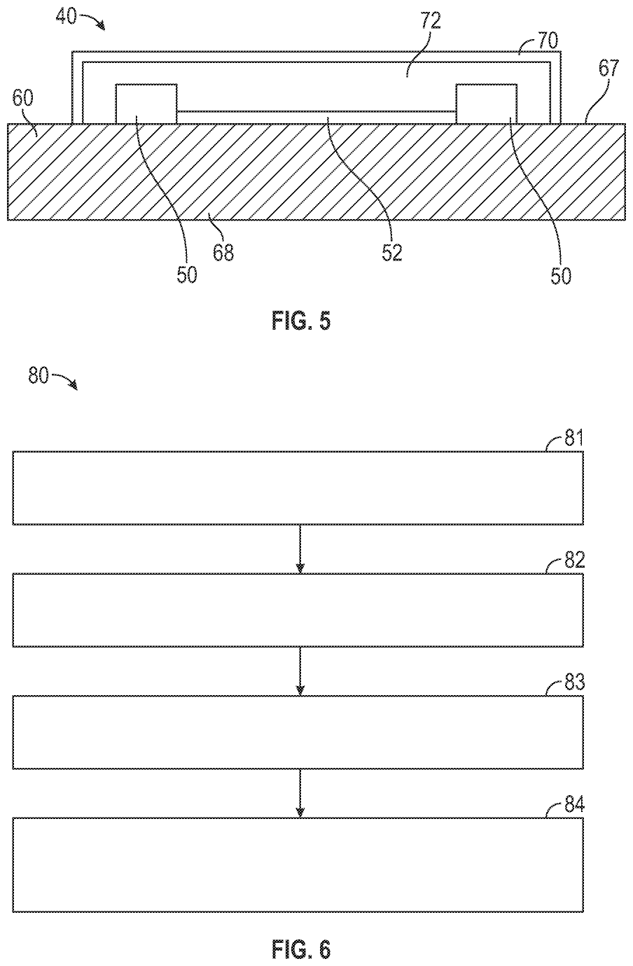

FIG. 5 depicts an example of the sound detection device 40, in which the transducer is attached to a transparent component made from tempered glass (or other component having a single layer or unitary structure). In this example, the window 60 is made from a single layer or panel of tempered glass 68. A sound detection device 40 includes a transducer, such as the piezoelectric transducer, attached to an interior surface 67 of the tempered glass 68. In an embodiment, attachment to the glass 68 is made with a non-rigid adhesive at a minimum thickness to adhere the transducer to the glass surface. The transducer can be adhered at any suitable location on the glass 68. Such suitable locations may include any location on a panel of the glass 68 that does not come into contact with interior trim or bonding adhesive used to secure the panel to the body of a vehicle.

The transducer may be enclosed in a protective housing 70 to prevent damage. The housing 70 may be filled with a material 72 for purposes such as holding the transducer in place, protecting transducer elements and/or isolating the transducer from internal sounds (e.g., the material 70 can include a sound absorbing material).

FIG. 6 depicts an embodiment of a method 80 of monitoring a vehicle environment. Aspects of the vehicle 10, the computer system 36, or other processing device or system, may be utilized for performing aspects of the method 80.

The method 80 is discussed in conjunction with blocks 81-84. The method 80 is not limited to the number or order of steps therein, as some steps represented by blocks 81-84 may be performed in a different order than that described below, or fewer than all of the steps may be performed.

The methods discussed herein are described in conjunction with the vehicle 10, but are not so limited and can be used in conjunction with various vehicles (e.g., cars, trucks, aircraft) and/or other systems (e.g., construction equipment, manufacturing systems, robotics, etc.).

At block 81, a monitoring system, which includes one or more sound detection devices 40 disposed at the vehicle 10, is activated to initiate monitoring of vehicle surroundings. The monitoring system may be activated in response to user input (e.g., a request entered via the user interface 38), or in response to detecting a vehicle operating condition or driving condition.

For example, the monitoring system is activated when the vehicle 10 is put into reverse. In other examples, the monitoring system can be activated in response to detecting various conditions, such as time of day, weather and others. Conditions detected using other vehicle sensors (e.g., radar assemblies 44 and/or cameras 42) may be used to trigger activation. For example, conditions detected using image analysis, such as the presence of pedestrians, vehicles and/or other objects, congested areas, traffic conditions and others, can be used trigger the monitoring system.

At block 82, sounds incident on a vehicle window are detected by one or more sound detection devices 40. For example, sounds from a source (e.g., an object such as a vehicle, a siren, a pedestrian, etc.) vibrate a window, and a transducer such as a piezoelectric transducer picks up the vibration and converts the vibration to electrical pulses.

At block 83, transducer signals are optionally processed (e.g., amplified, filtered, etc.), and then transmitted to a vehicle system. Transmission may be to a vehicle computer system (e.g., the computer system 36), an imaging system, an autonomous control system, and others. In an embodiment, the signals are transmitted to a vehicle entertainment system or other system that controls vehicle speakers (e.g., speakers 90, 92L and 92R).

In addition, transducer signals can be processed to determine properties of the source that emitted detected sounds. For example, a region or zone of the vehicle 10 at which the sounds are detected is identified and used to determine a direction of the sound. In other examples, the amplitude of sounds may be measured and correlated to distance of the emitting source.

At block 84, a notification is provided to a user and/or vehicle system. The notification to a user may be visual, such as a textual notification or graphical representation. Other notifications, such as haptics, indicator lights and/or voice notifications may be used.

In an embodiment, the notification is provided by controlling vehicle speakers to reproduce detected sounds. For example, when a sound is detected (e.g., a siren), the monitoring system determines the location or region of the sound detection device 40 that detected the sound. A speaker in a vehicle zone that includes the device is activated by reproducing the sound (e.g., by turning the speaker on or interrupting music or other speaker outputs). As a source of the sound moves and detection devices 40 in different vehicle zones detect the sound, the monitoring system tracks movement of the source of the sound based on changes in which sound detection device 40 detects the sound (and/or detects changes in amplitude of signals received from a transducer). Respective speakers may be activated based on the changes to simulate the movement.

For example, if an emergency vehicle approaches the vehicle 10 from the right rear, a sound detection device 40 at a right-hand side of the rear window 32 detects a siren sound, and a rear speaker 90 closest to the detection device 40 that detected the sound is activated and reproduces the siren sound. As the emergency vehicle passes the vehicle 10, a sound detection device 40 at a right-hand side window 34 picks up the sound and a corresponding right side speaker 92R is activated. Transitioning between speakers in this way may include gradually lowering the volume of one speaker and gradually increasing the volume of another speaker to simulate movement and give the user a more realistic simulation of what would be heard from an exterior of the vehicle.

In addition to, or alternative to notifying a user, the monitoring system can provide an indication or information to systems that autonomously control the vehicle.

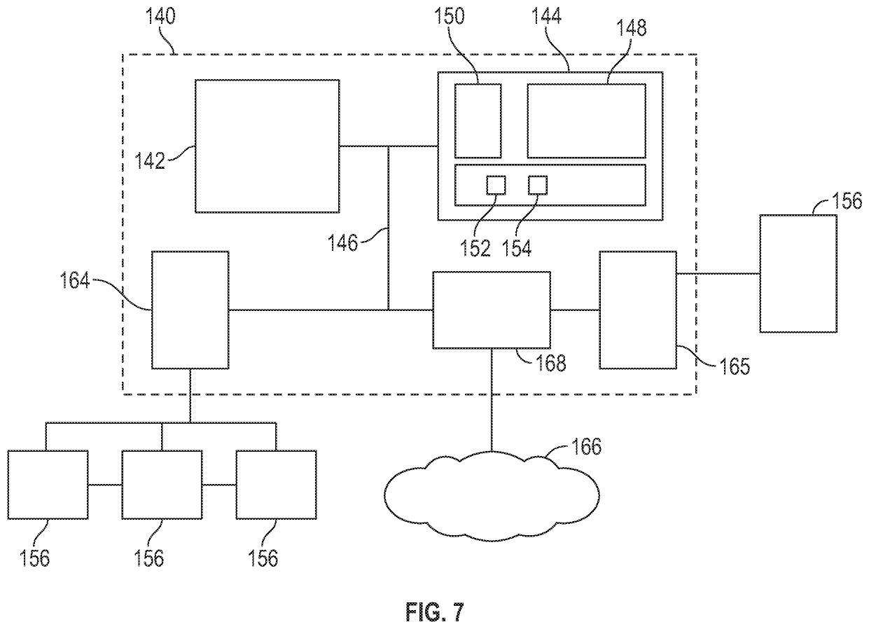

FIG. 7 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring system components, and a module 154 may be included to perform functions related to controlling notifications as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A monitoring system of a vehicle, comprising:
a sound detection device including a sound transducer attached to a transparent component of the vehicle, the sound detection device configured to detect vibrations of the transparent component due to a sound originating from an external environment around the vehicle; and
a processor configured to detect a signal generated by the sound transducer, the signal indicative of the sound.

2. The monitoring system of claim 1, wherein the transparent component includes a first rigid transparent layer bonded to a second rigid transparent layer by a deformable material, and the sound transducer is disposed in the deformable material.

3. The monitoring system of claim 2, wherein the first rigid transparent layer is an external layer exposed to the external environment, the second rigid transparent layer is an internal layer, and the sound transducer is disposed in contact with the external layer.

4. The monitoring system of claim 1, wherein the sound transducer is affixed to an interior surface of the transparent component.

5. The monitoring system of claim 1, wherein the sound transducer includes a piezoelectric material.

6. The monitoring system of claim 1, wherein the processor is configured to determine at least one of a direction of a source of the sound, and a distance of the source from the vehicle, and output an indication of at least one of the direction of the source of the sound and the distance of the source of the sound.

7. The monitoring system of claim 6, wherein the processor is configured to output the indication by controlling a speaker of the vehicle, the speaker being in a region of the vehicle that corresponds to a location of the sound transducer.

8. The monitoring system of claim 7, wherein the processor is configured to track the direction of the source of the sound, and indicate a change in the direction of the source of the sound by transitioning outputs between different speakers.

9. The monitoring system of claim 1, wherein the transparent component is selected from laminated glass and tempered glass, the transparent component forming a vehicle window.

10. A method of monitoring an environment around a vehicle, comprising:
detecting a sound by a sound detection device including a sound transducer attached to a transparent component of the vehicle, wherein detecting the sound includes detecting vibrations of the transparent component due to the sound; and
detecting a signal generated by the sound transducer in response to the vibrations, and generating a notification indicative of the sound.

11. The method of claim 10, wherein the transparent component includes a first rigid transparent layer bonded to a second rigid transparent layer by a deformable material, and the sound transducer is disposed in the deformable material.

12. The method of claim 11, wherein the first rigid transparent layer is an external layer exposed to an external environment, the second rigid transparent layer is an internal layer, and the sound transducer is disposed in contact with the external layer.

13. The method of claim 10, wherein the sound transducer is affixed to an interior surface of the transparent component.

14. The method of claim 10, further comprising determining at least one of a direction of a source of the sound, and a distance of the source from the vehicle, and outputting an indication of at least one of the direction of the source of the sound and the distance of the source of the sound.

15. The method of claim 14, wherein outputting the indication includes controlling a speaker of the vehicle, the speaker being in a region of the vehicle that corresponds to a location of the sound transducer.

16. The method of claim 15, further comprising tracking the direction of the source of the sound, and indicating a change in the direction of the source of the sound by transitioning outputs between different speakers.

17. A vehicle system, comprising:
a memory having computer readable instructions; and
a processor for executing the computer readable instructions, the computer readable instructions controlling the processor to perform a method including:
detecting a sound by a sound detection device including a sound transducer attached to a transparent component of the vehicle, wherein detecting the sound includes detecting vibrations of the transparent component due to the sound; and
detecting a signal generated by the sound transducer in response to the vibrations, and generating a notification indicative of the sound.

18. The vehicle system of claim 17, wherein the method further includes determining at least one of a direction of a source of the sound, and a distance of the source from the vehicle, and outputting an indication of at least one of the direction of the source of the sound and the distance of the source of the sound.

19. The vehicle system of claim 18, wherein outputting the indication includes controlling a speaker of the vehicle, the speaker being in a region of the vehicle that corresponds to a location of the sound transducer.

20. The vehicle system of claim 19. wherein the method further includes tracking the direction of the source of the sound, and indicating a change in the direction of the source of the sound by transitioning outputs between different speakers.
